(19) United States
(12) Patent Application Publication
(10) Pub. No.: US 2017/0355587 A1
(43) Pub. Date: Dec. 14, 2017

(54) OIL DISPENSER

(71) Applicant: Michelle Leonease Hinsey, Lake Worth, FL (US)

(72) Inventor: Michelle Leonease Hinsey, Lake Worth, FL (US)

(21) Appl. No.: 15/003,639

(22) Filed: Jun. 9, 2016

(51) Int. Cl. B67D 7/04; B67D 7/84; B67D 7/40; B67D 7/16; B67D 7/62; B67D 7/22

(52) U.S. Cl. CPC B67D 7/04; B67D 7/62; B67D 7/224; B67D 7/40; B67D 7/16; B67D 7/84

(57) ABSTRACT

An oil fill dispenser invention. A system for dispensing of variation are in the number of hoses and grades of oil. Which utilizes electronic computer that embedded and house to control the meter flows. The grades of fuel accurately supplying the amount of fuel and compute the money pricing of the fuel. The distribution system control the flow meter and direct measuring of fuel action and different grades and pricing of the dispensed.

### BACK GROUND OF THE INVENTION

### 1. The Field of Invention

This invention is related to a gas dispenser at a service station; it is to be installed at a services station. To dispense fuel for automobiles.

### 2. Statement of the Prior Art

The oil fill dispenser installation is on the ground. The machine body is where the oil is in-house in the oil reservoir at the top of the body of the machine. The flow meter dial is place in front near the top of the machine body which supply the amount of oil and grade.

The retractable hoses are below the flow meter. The retractable hoses are drawn forward by hand holding the cord easily reaching the vehicle oil fill location. The major variation is in the number of hoses and grades of oil it can dispense. A mechanical computer and counting device which in tally fluid delivery and a proportional pricing data as read from the display face of the pump installation. Embedded computer to control the action of the pump.

### SUMMARY OF THE INVENTION

The object of this present invention is to provide an oil dispenser system that will help the environment the land fill. Embedded computer controls the preselect amount of fuel and grades of fuel. There is a pay by card method on front side of the body of the machine. The flow meter is at the top portion of the machine; below the dial of the flow meter a plurality of oil filling retractable hoses that are arranged at mid portion of the body of the in house side by side for filling two or more grades of oil. The retractable hoses are; elastically supported. The drip catcher is below the retractable hoses nozzle to gather drips from the nozzle into the oil drain reservoir at the lower bottom of the body of the machine. At the mid portion below the body of the machine the retractable hoses are hanging downward in front of the in house body; the drip catcher is under the pumps gathering oil that drip from the nozzle of the pump, filter into the oil drain reservoir. The top portion of the body in housing the oil reservoir the bottom of the body in housing the oil drain reservoir.

The top portion of the body and the bottom portion is connected by sheet steel of metal.

In housing the three pumps that lead from the main body of the machine, the other end of the retractable hoses is connected in house to a discharge pipe embedded. It preferable that the retractable hoses be provided at the front of the body of the machine.

The dial for the flow meter is place in front of the body of the machine above the retractable hoses. The retractable hoses is line up side by side in front of the machine body; this way the oil filling location is effectively utilized.

15. The oil fill dispenser has three retractable hoses that are easily pulled by hand and placed into the vehicle filling location. The hoses are robust to survive heavy weather and tear, exposure to weather. The hoses at the front main body of the machine effective to supply a plurality of different grade of oil.

20. The embedded computer to control the action of the pump has an electric motor pumping unit that is encased in the machine body.

25. The functional element of this invention is shown in the drawing

30. It preferable that the main body of the oil fill dispenser is made of metal, the outer housing of the pumps is made of sheet steel metal.

35. The above mentioned structure of the oil fill dispenser of the present invention. The hoses can be easily handled by hand to be drawn forward smoothly with guidance. The retractable hoses are brought back to the initial state. Nozzles are attached to the retractable pump. It attached using heavy spring coil to provide strength to the hoses. A plurality of hoses is place side by side.

40. Other features of this invention will become apparent in the course of all following description of embodiment which are giving for illustration.

### BRIEF DESCRIPTION OF THE DRAWINGS

FIG. 1. The diagram of the oil fill dispenser station a dispensing system accordance to the invention.

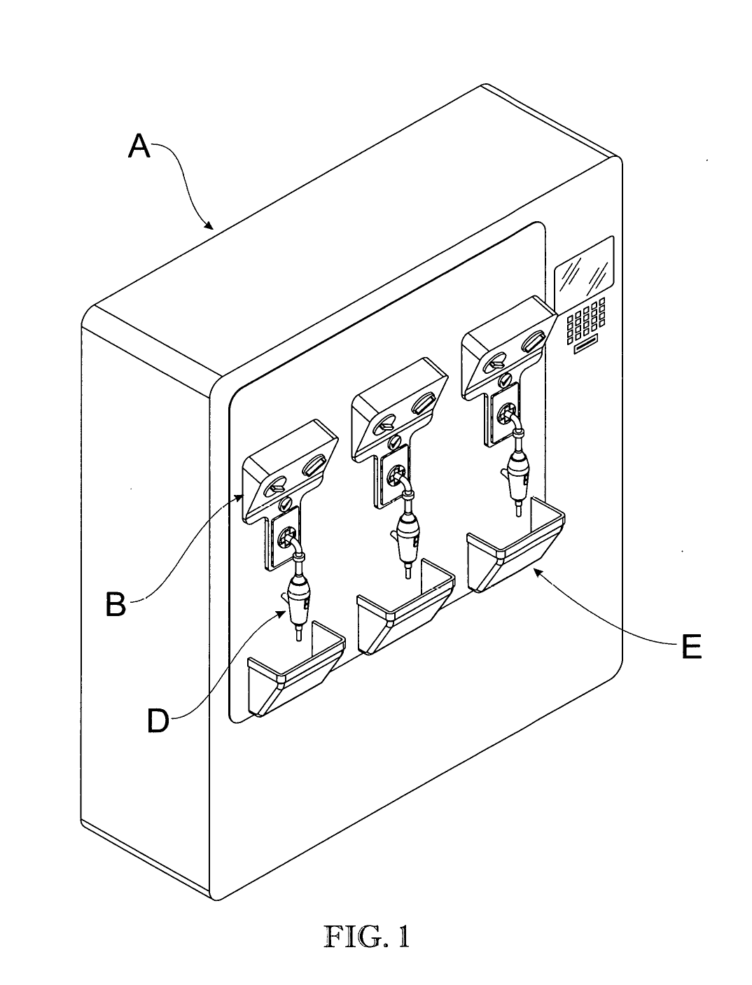

FIG. 2. A view of the display panel of the oil dispenser that can be utilized at a service station

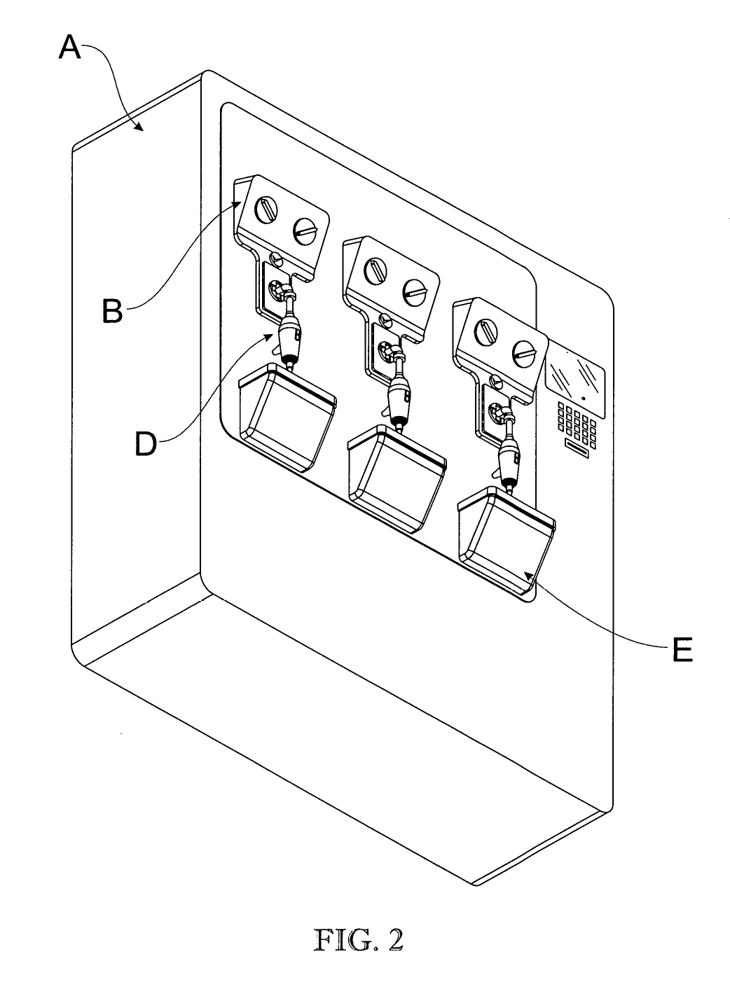

FIG. 3. Diagram of a dispensing system. Mid top main body is the flow meter the dials. Middle portion is the retractable pump as in FIG. 1

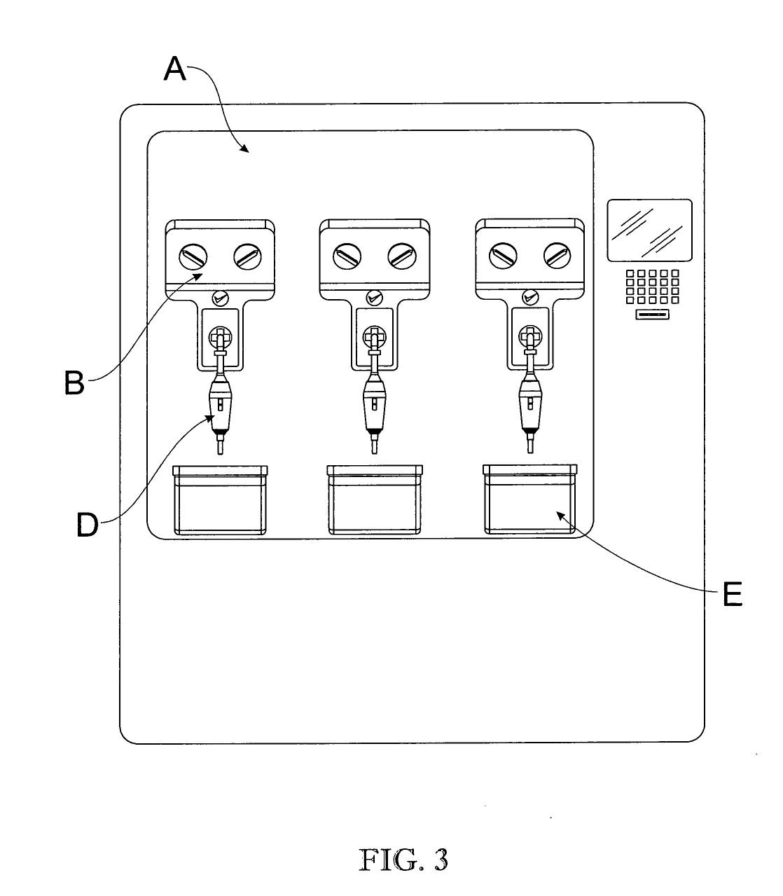

FIG. 4. The retractable pump extended forward shows the pump and the nozzle at the end show the method of payment on the front of the main body of the in house.

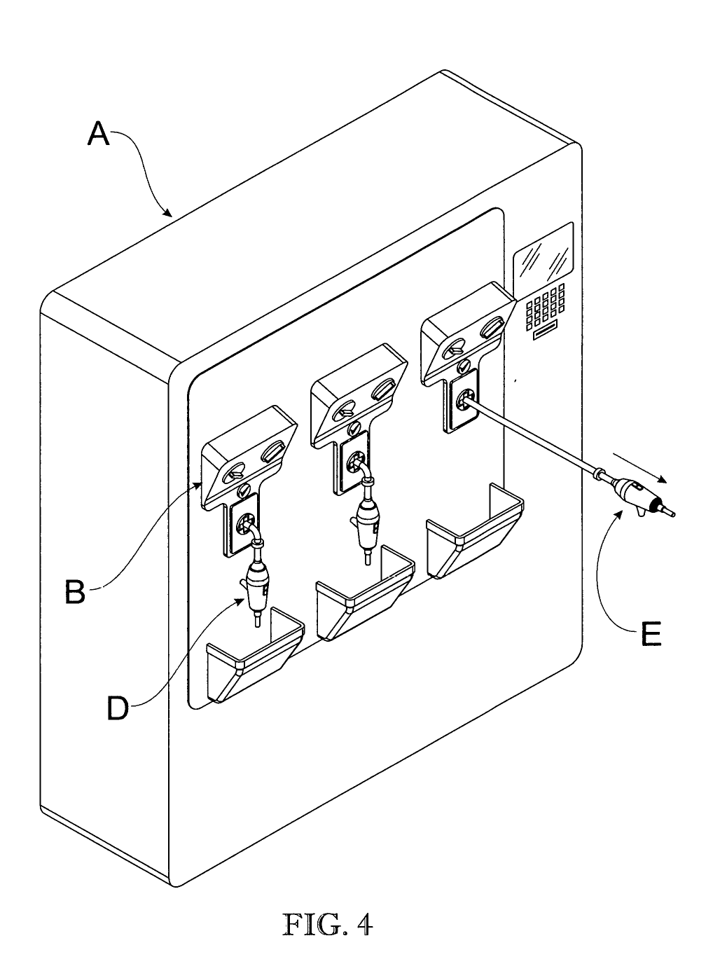

FIG. 5. The retractable hoses pulled forward, the hose easily reaches the vehicle oil location the retractable hoses easy to operate by hand pulling forward.

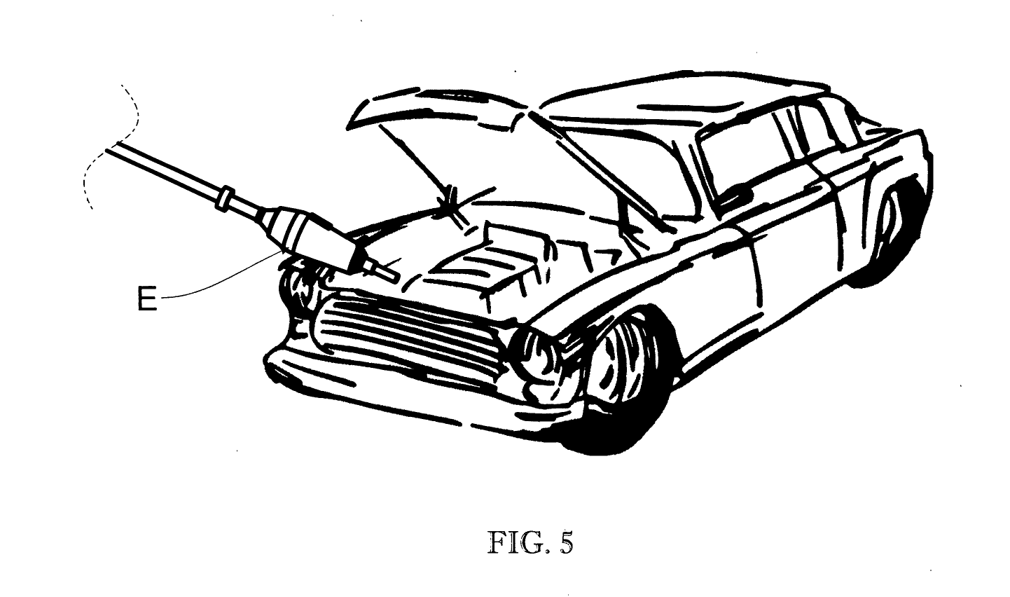

FIG. 6. Diagram of the dispensing system at the top of the body shows the oil reservoir that is located at the top of the meter flow dial.

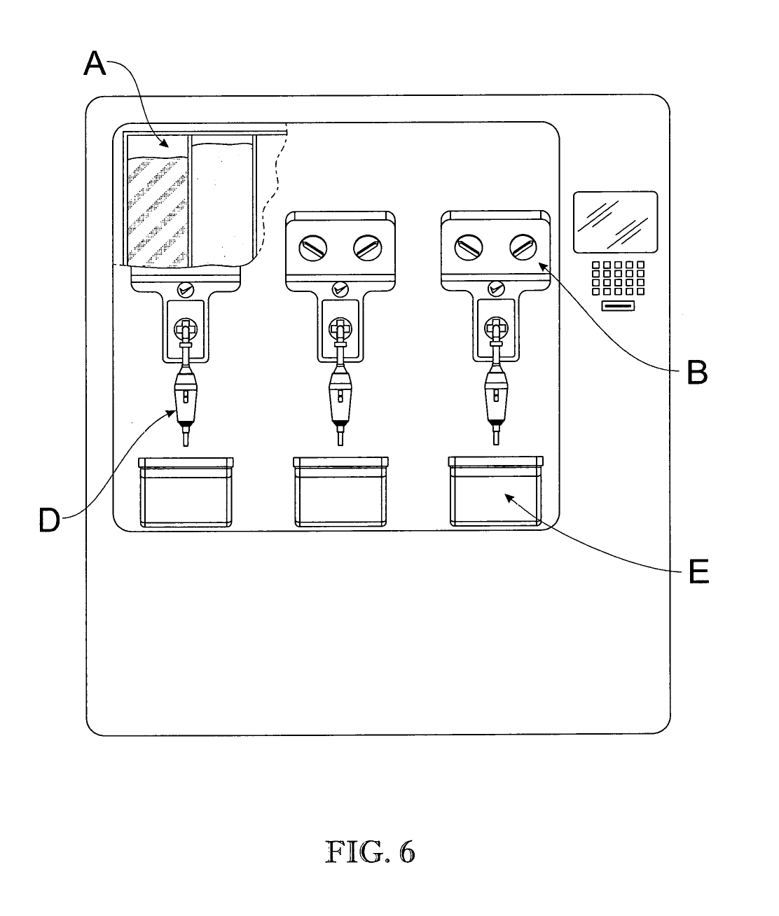

FIG. 7. Shows the top portion of the body of the oil fill dispenser that connect to bottom. It shows a hose guide from the main body of the oil filled dispenser embedded extended to a part at the top body of the in house connected to a discharged pipe provided at the inside of the flow meter a part of the retractable hoses that release the fuel to the nozzle of the dispensing, fuel already measure to the accurate amount showing the flow of the oil reservoir the dip catcher is shown below the nozzle of the pump to gather the oil and drain into the oil drain reservoir through the filter that is at the bottom of the drip catcher.

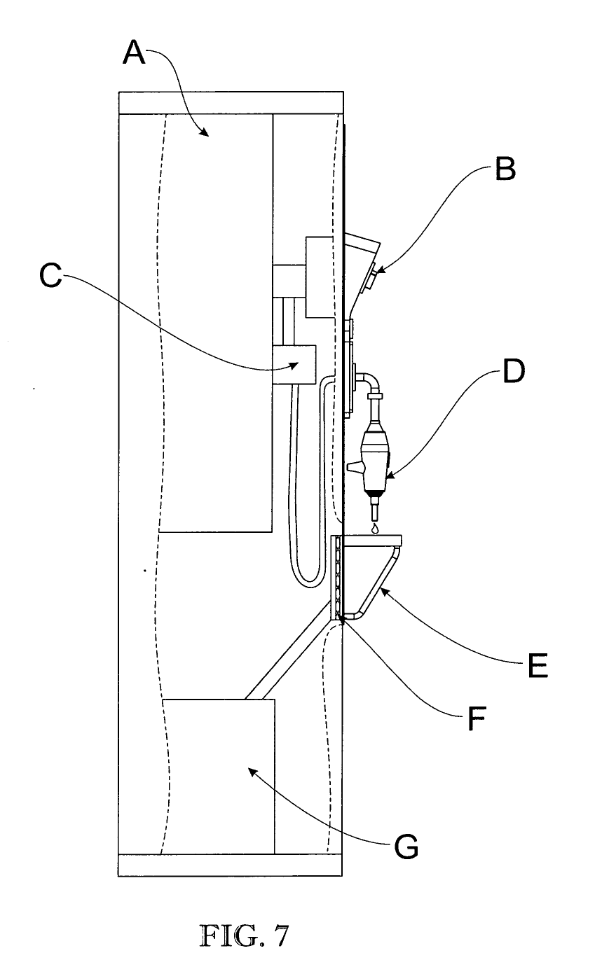

FIG. 8. Diagram of the invention of the oil fill

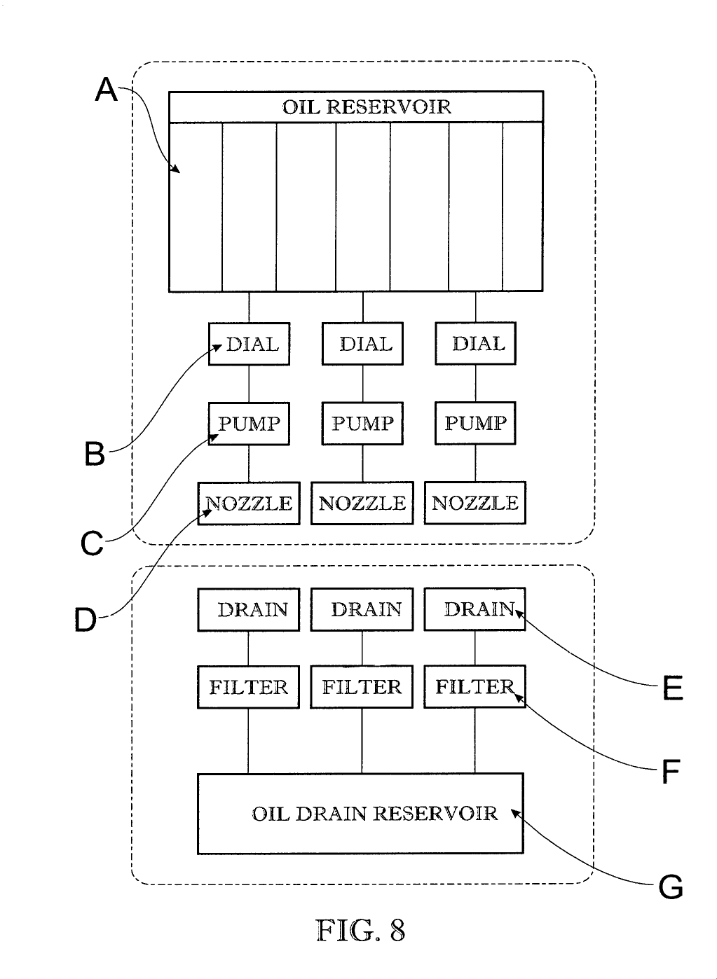

A. Top body is oil reservoir
B. Top middle body is the dial the flow meter
C. Pump
D. Nozzle

I claim:

1. An oil fill dispenser system comprising.

2. An Oil Fill Dispenser system unit for housing a plurality of oil and pumps that are arranged side by side on the front body of the dispenser.

3. A fuel filling apparatus comprising a fuel reservoir.

4. A dispensing nozzle a pumping means for transferring the fuel from the reservoir and dispensing the fuel through the nozzle which already measure to the accurate amount into a vehicles filling inlet.

5. A computer that controls the action of the pumps has an electric motor pumping unit control the fuel flow.

6. Calculate, and displayed cost and the amount of each fuel dispensed.

7. An automotive fuel dispensing system as in claim where there is a plurality of fuel pumping.

8. Automotive fuel fill dispensing system as in claim 1 further comprising.

9. The distribution system controlling the flow meter the different grades of oil and on command, prints out cost and amount of each variation of fuel dispensed as in claim. 6

10. The outer housing of the pump is made of sheet steel of metal that encase the computer that control the action of the flow meter and the pump as in claim. 5
